(19) United States
(12) Patent Application Publication
(10) Pub. No.: US 2025/0089634 A1
(43) Pub. Date: Mar. 20, 2025

(54) VEGETABLES, MUSHROOMS OR HERBS IN A BOX

(71) Applicant: RIJK ZWAAN ZAADTEELT EN ZAADHANDEL B.V., De Lier (NL)

(72) Inventors: Wilhelmus Petrus Adrianus Roeland VOERMANS, De Lier (NL); Jeanette Diana VAN DER LAKEN, De Lier (NL); Michiel Anton ZWAAN, De Lier (NL); Marc Alfons Constant CELIS, De Lier (NL)

(21) Appl. No.: 18/621,666

(22) Filed: Mar. 29, 2024

Related U.S. Application Data
(62) Division of application No. 13/792,022, filed on Mar. 9, 2013, now abandoned.

(30) Foreign Application Priority Data
Oct. 11, 2012 (EP) 12188114.8

(51) Int. Cl. A01G 22/40; A01G 9/02; A01G 9/029; A01G 18/64; A01G 22/15; A01G 22/35; A01G 31/00; B65D 85/52

(52) U.S. Cl. CPC A01G 22/40; A01G 9/02; A01G 9/0293; A01G 18/64; A01G 22/15; A01G 22/35; A01G 31/00; B65D 85/52

(57) ABSTRACT

The present invention relates to a method for producing consumer-ready vegetables, mushrooms or herbs, comprising the steps of culturing vegetables, mushrooms or herbs in a closed container under suitable growing conditions until maturity; and transferring the container with the mature vegetable, mushrooms or herb to a retail outlet. The culturing of the vegetables, mushrooms or herbs until maturity takes suitably place in or in the vicinity of the retail outlet. The invention further relates to a set for performing the method and to the container comprising the mature vegetables, mushrooms or herbs.

### RELATED APPLICATIONS AND INCORPORATION BY REFERENCE

This application is a divisional of U.S. application Ser. No. 13/792,022 filed Mar. 9, 2013, which application claims benefit of European patent application Serial No. 12188114.8 filed 11 Oct. 2012.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to a method for producing consumer-ready vegetables, mushrooms or herbs. The invention also relates to a set that may comprise the constituents for performing the method and a container which may comprise the vegetable, mushrooms or herb.

### BACKGROUND OF THE INVENTION

Vegetables, mushrooms and herbs are traditionally produced by specialized growers in greenhouses or on fields. After harvest the produce needs to be transported to a retail outlet. The transportation costs have an impact on the final consumer prize. Moreover, it is sometimes necessary to store the produce before they are distributed. For certain products this may require specialized storage facilities.

Citation or identification of any document in this application is not an admission that such document is available as prior art to the present invention.

### SUMMARY OF THE INVENTION

It is an object of the invention to provide a new way of producing vegetables, herbs and mushrooms that leads to lower costs and a fresher product.

The present invention relates to a method for producing consumer-ready vegetables, mushrooms or herbs, which may comprise the steps of: culturing vegetables, mushrooms or herbs in a closed container under suitable growing conditions until maturity; and transferring the container with the mature vegetable, mushrooms or herb to a retail outlet. The container may be provided with a label with information regarding the vegetable, mushrooms or herb.

The culturing of the vegetables, mushrooms or herbs until maturity may take place in or in the vicinity of the retail outlet. The container may be closed with a permeable membrane. The membrane may be permeable to oxygen (O₂) and carbon dioxide (CO₂) but preferably impermeable to contaminations and pathogens, such as viruses, bacteria, fungi, protists or insects.

Prior to culturing the vegetables, mushrooms or herbs, a seed, germinated seed, seedling or small plant for the vegetable or herb or mycelium for the mushrooms may be placed on or in a substrate in the container and the container may be closed. The seeds may be provided in the form of a seed mat or seed band. The substrate may comprise nutrients for the vegetables, mushrooms or herbs.

The vegetables may be leafy vegetables, in particular lettuce, in particular leaf lettuce, head lettuce or baby leaf lettuce, endive, rucola, lamb lettuce, corn salad, chard, leaf beet, spinach, radish, sprout vegetables, in particular, cress, beet sprouts, alfalfa, broccoli sprouts, bean sprouts, fennel sprouts, cabbage sprouts, garlic sprouts, leek sprouts, pea sprouts, chickpea sprouts, or wherein the herbs are selected from chives, parsley, basil, dill weed, coriander, cilantro, mint, oregano, rosemary, thyme, marjoram, lemon balm.

The invention also encompasses a set for producing consumer-ready vegetables, mushrooms or herbs, which may comprise a container, a substrate, sowing or planting material and a permeable membrane. The size and form of the container may correspond with the size and form of the mature vegetable or herb or the quantity of mushrooms to be produced. The membrane may be at least partially self-adhesive. The substrates and seeds may be placed in the container and the container is closed with the membrane and the container may be provided with means to allow a fluid to be introduced, in particular valve means.

The present invention also encompasses a container which may comprise a vegetable, mushrooms or herb, obtainable by the methods disclosed herein. The contain may be a square box, a rectangular box or a tube.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1A-1C shows how the substrate and the seed is placed in the still open container. FIG. 1A) is a square box for one lettuce plant. FIG. 1B) is a tube for herbs. FIG. 1C) is a rectangular box for baby leaf lettuce.

FIG. 2 shows the closed boxes with the growing plants corresponding with FIG. 1A-1C.

FIG. 3 shows a growing facility with a number of boxes.

FIG. 4 shows the boxes with the mature plants corresponding with FIG. 1A-1C.

FIG. 5 shows the boxes when labelled and placed in the supermarket.

### DETAILED DESCRIPTION OF THE INVENTION

The present invention thus provides a method for producing consumer-ready vegetables, mushrooms or herbs, which may comprise the steps of:
a) culturing vegetables, mushrooms or herbs in a closed container under suitable growing conditions until maturity; and
c) transferring the container with the mature vegetable, mushrooms or herb to a retail outlet.

In a preferred embodiment, culturing of the vegetables, mushrooms or herbs until maturity takes place in or in the vicinity of the retail outlet. Suitably the products are cultured in storage rooms or basements of the retail outlet. This way the transportation costs are saved. Moreover, the products need not be stored between harvest and transport to their point of sale and are therefore more fresh. The retail outlet is suitably a supermarket but other types of stores may be envisaged as well.

It is not necessary for the method of the invention to be performed in the retail outlet itself. It is also possible that the products are grown in regional facilities to supply multiple retail outlets in the area thus still having part of the benefit of lower transportation costs.

The growth facilities are preferably provided with specialized lighting systems designed to provide the correct light intensity and colour, in particular well know assimilation lighting. Such systems may be automatically controlled to allow for a light and darkness cycle that is particularly adapted to the type of vegetable or herb.

Prior to culturing the vegetables, mushrooms or herbs, seed for the vegetable or herb or spores for the mushrooms is placed on or in a substrate in the container and the container is closed. Alternatively, a germinated seed, seedling or plantlet of the vegetable or herb or mycelium for the mushrooms is placed on or in the substrate in the container before closing it.

In one embodiment the substrate is placed in the container as part of the method. In an alternative embodiment, the container is already provided with the substrate. In a further embodiment the seeds, spores, seedlings, plantlets or mycelium are also included and the container is already closed.

In order to germinate, the seeds or spores need to be in contact with a fluid, such as water or a buffer. Suitably, closing the container is done after introducing the water in the container. Since the container is not opened before the product is ready to be consumed all nutrients and water needed to obtain a mature product are to be included in the container before closure thereof.

Suitably, the container is closed with a permeable membrane. The membrane is permeable to oxygen (O₂) and carbon dioxide (CO₂) but preferably impermeable to contaminations and pathogens, like viruses, bacteria, fungi, protists or insects. The products thus grow in a contamination- and pathogen-free environment. The resistance requirements for the products are much lower than for growing in a greenhouse or on the field. Each plant or mushrooms is individually packed and cannot contaminate other plants or be contaminated. The retailer may thus use seeds that may comprise fewer resistances which as a consequence of the lower development costs is more cost-effective.

After sowing the seeds or spores or planting the germinated seeds, seedlings, plantlets or mycelium the container is closed with the membrane to be re-opened only by the consumer after the product is sold. Thus, the product itself does not require handling and remains much more hygienic.

The method of the invention is in particularly suitable for leafy vegetables, in particular lettuce, endive, rucola, lamb lettuce, corn salad, chard, leaf beet, spinach, radish. The vegetables may also be sprout vegetables, such as cress, beet sprouts, alfalfa, broccoli sprouts, bean sprouts, fennel sprouts, cabbage sprouts, garlic sprouts, leek sprouts, pea sprouts, chickpea sprouts.

The lettuce is for example leaf lettuce, head lettuce or baby leaf lettuce. For baby leaf lettuce different lettuce varieties may be used to obtain an attractive mixture. In one embodiment, two or more lettuce seeds of different varieties are used to obtain a mix of different leaf or head lettuce plants.

The herbs are for example selected from chives, parsley, basil, dill, coriander, cilantro, mint, oregano, rosemary, thyme, marjoram, lemon balm. In a particular embodiment, mixtures of herbs may be produced such as an Italian herb mix or French herb mix.

Mixtures of mushrooms may also be made by using different spores. The method may also be used for obtaining one large mushroom such as a Portobello mushroom.

In a particular embodiment, the seeds may be provided in the form of a seed mat, seed band or any other form. This is especially practical for mixtures of vegetables or herbs so that the correct seed distance is automatically obtained upon placing the mat on the substrate.

The substrate suitably may comprise nutrients for the vegetables, mushrooms or herbs. For each type of product a corresponding substrate may then be designed wherein the suitable amount of nutrients is contained. It is furthermore possible to include the nutrients in the fluid that is to be added to the substrate. The substrate and fluid together may have the form of a gel in which the plant or mushroom may grow.

The container is preferably provided with a label with information regarding the vegetable, mushrooms or herb. The information may comprise for example the name of the vegetable, nutritional fact, best before date and the price. In addition to such sales information, other information, such as recipes, may be included as well. The container may also be provided with a paper wrap that contains such information.

The label or wrap may be applied prior to or immediately after closing the container. Alternatively, the label or wrap is applied directly before transfer to the retail outlet. When applying the label or wrap care should be taken that the upper side is not so covered that entrance of light into the container is hampered.

The invention further relates to a set for producing consumer-ready vegetables, mushrooms or herbs, which may comprise a container, a substrate, sowing or planting material and a permeable membrane.

Both with respect to the method and the set, the size and form of the container preferably correspond with the size and form of the mature vegetable or herb or the quantity of mushrooms to be produced. The container may also have any other form as well.

Suitably, the closing membrane is at least partially self-adhesive, in particular at the edges. The membrane may then be easily stuck to the open side of the container to seal it off.

In one embodiment of the set, the substrates and seeds are already placed in the container and the container is already closed with the membrane. In this embodiment no moisture should be present in the container because that might lead to premature germination. In order to introduce the fluid the container is then provided with means to allow the fluid to enter the container. Such means are for example valve means that avoid entrance of contaminants and pathogens.

The invention further relates to a container which may comprise a vegetable, mushrooms or herb, obtainable by the method as claimed. The container is suitably adapted to the form of the product. It may be a square box, a rectangular box or a tube or any other form.

The invention may be performed without the contribution of the grower. The retailer may buy his seed directly from seed companies. Since one step in the chain is now no longer necessary the retailer may produce his own vegetables, mushrooms and herbs at a significantly lower cost.

Although the present invention and its advantages have been described in detail, it should be understood that various changes, substitutions and alterations can be made herein without departing from the spirit and scope of the invention as defined in the appended claims.

The present invention will be further illustrated in the following Examples which are given for illustration purposes only and are not intended to limit the invention in any way.

### EXAMPLES

### Example 1

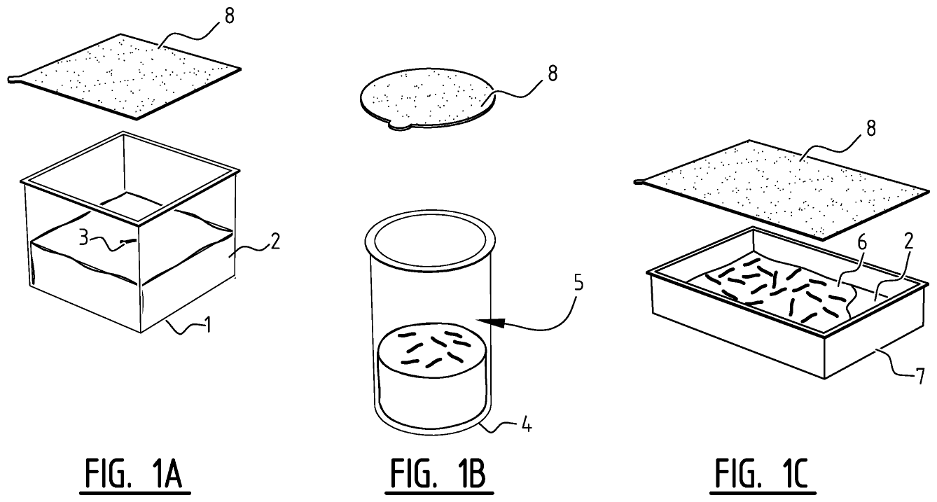

FIG. 1A shows a square box 1 with a substrate 2 on which one seed 3 is placed. In FIG. 1B a tube 4 is shown that may comprise multiple seeds 5 for growing chives. In FIG. 1C a seed mat 6 which may comprise a mixture of lettuce seed is placed on the substrate 2 in a rectangular container 7.

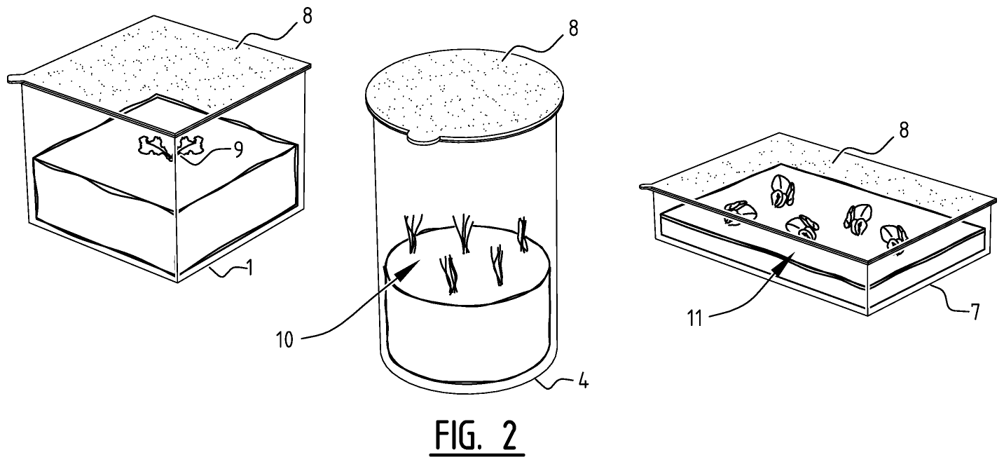

After sowing water is introduced in the containers 1, 4 and 7, after which they are closed with a permeable membrane 8 that is stuck to the edges of the upper end of the containers. The boxes 1, 4 and 7 are then subjected to a growing regime adapted to the product to be grown. The seeds will germinate and plantlets 9, 10 and 11 are visible in FIG. 2.

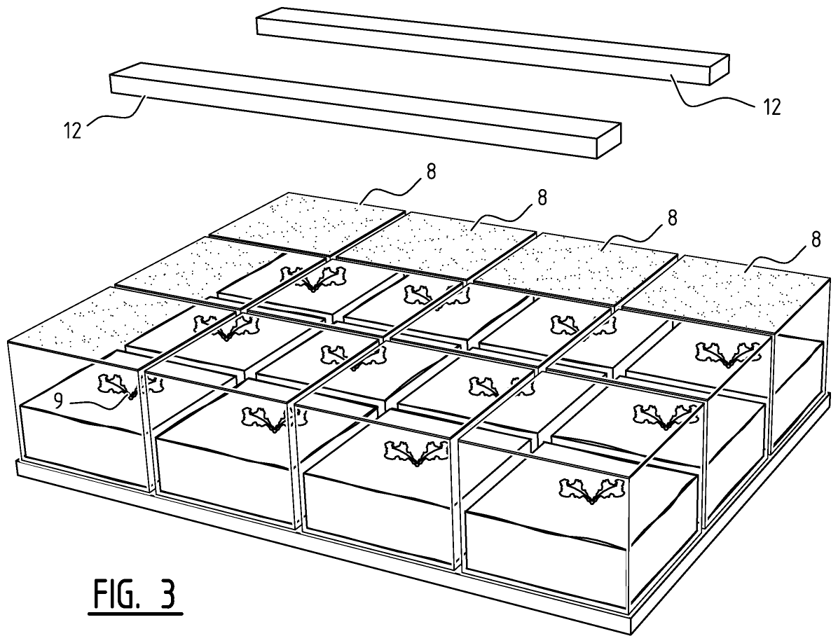

FIG. 3 shows how lettuce heads are grown in individual boxes that are sealed with a permeable membrane 8 in the basement of a supermarket. Assimilation lightning 12 is installed to provide the plants with the correct light.

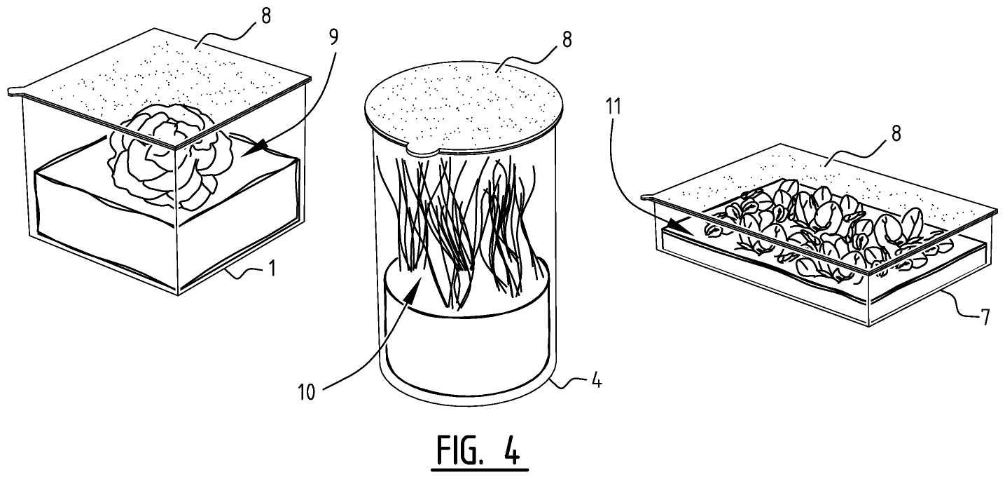

In FIG. 4 the mature products are shown. The boxes 1 and 7 contain a mature lettuce head 9 and the baby lettuce plants 11, respectively. In box 4 a chives plant 10 is visible.

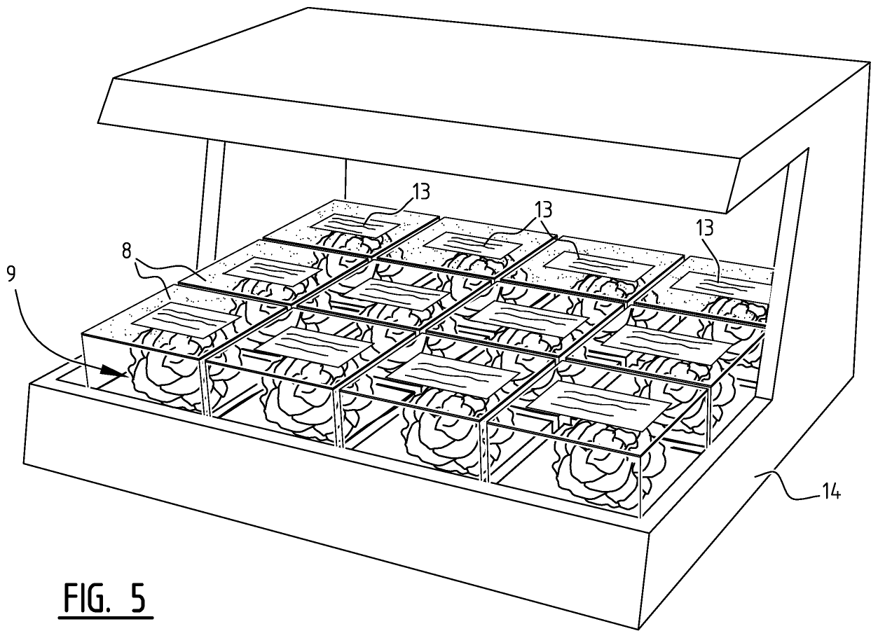

FIG. 5 shows how a head of lettuce 9 grown in a closed container 8 after being provided with a label 13 may be presented in a display or cooling unit 14 in a supermarket.

The invention is further described by the following numbered paragraphs:
1. Method for producing consumer-ready vegetables, mushrooms or herbs, comprising the steps of:
   a) culturing vegetables, mushrooms or herbs in a closed container under suitable growing conditions until maturity; and
   c) transferring the container with the mature vegetable, mushrooms or herb to a retail outlet.
2. Method of paragraph 1, wherein culturing of the vegetables, mushrooms or herbs until maturity takes place in or in the vicinity of the retail outlet.
3. Method of paragraph 1 or 2, wherein the container is closed with a permeable membrane.
4. Method of paragraph 3, wherein the membrane is permeable to oxygen (O₂) and carbon dioxide (CO₂) but preferably impermeable to contaminations and pathogens, such as viruses, bacteria, fungi, protists or insects.
5. Method of any one of the paragraphs 1-4, wherein prior to culturing the vegetables, mushrooms or herbs, a seed, germinated seed, seedling or small plant for the vegetable or herb or mycelium for the mushrooms is placed on or in a substrate in the container and the container is closed.
6. Method of any one of the paragraphs 1-5, wherein the vegetables are leafy vegetables, in particular lettuce, in particular leaf lettuce, head lettuce or baby leaf lettuce, endive, rucola, lamb lettuce, corn salad, chard, leaf beet, spinach, radish, sprout vegetables, in particular, cress, beet sprouts, alfalfa, broccoli sprouts, bean sprouts, fennel sprouts, cabbage sprouts, garlic sprouts, leek sprouts, pea sprouts, chickpea sprouts, or wherein the herbs are selected from chives, parsley, basil, dill weed, coriander, cilantro, mint, oregano, rosemary, thyme, marjoram, lemon balm.
7. Method of any one of the paragraphs 1-6, wherein the seeds are provided in the form of a seed mat or seed band.
8. Method of any one of the paragraph 1-7, wherein the substrate comprises nutrients for the vegetables, mushrooms or herbs.
9. Method of any one of the paragraph 1-8, wherein the container is provided with a label with information regarding the vegetable, mushrooms or herb.
10. Set for producing consumer-ready vegetables, mushrooms or herbs, comprising a container, a substrate, sowing or planting material and a permeable membrane.
11. Set of paragraph 10, wherein the size and form of the container correspond with the size and form of the mature vegetable or herb or the quantity of mushrooms to be produced.
12. Set of paragraph 10 or 11, wherein the membrane is at least partially self-adhesive.
13. Set of any one of the paragraphs 10-12, wherein the substrates and seeds are placed in the container and the container is closed with the membrane and the container is provided with means to allow a fluid to be introduced, in particular valve means.
14. Container comprising a vegetable, mushrooms or herb, obtainable by the method of any one of the paragraphs 1-9.
15. Container of paragraph 14, which is a square box, a rectangular box or a tube.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A consumer-ready-to-be-consumed spinach plant in a closed container that the consumer-ready-to-be-consumed spinach plant was grown in, or a consumer-ready-to-be-consumed lettuce plant in a closed container that the consumer-ready-to-be-consumed lettuce plant was grown in, said consumer-ready-to-be-consumed spinach plant in the closed container or said consumer-ready-to-be-consumed lettuce plant in the closed container produced by a method comprising the steps of:
a) assembling in a container, materials for producing the consumer-ready-to-be-consumed spinach plant in the closed container or the consumer-ready-to-be-consumed lettuce plant in the closed container comprising:
i) spinach or lettuce seed, spinach or lettuce germinated seed, spinach or lettuce seedling, or small spinach or lettuce plant,
ii) water for growth to the consumer-ready-to-be-consumed spinach plant in the closed container or the consumer-ready-to-be-consumed lettuce plant in the closed container of the spinach or lettuce seed, the spinach or lettuce germinated seed, the spinach or lettuce seedling, or the small spinach or lettuce plant under suitable growing conditions, and
iii) substrate for growth to the consumer-ready-to-be-consumed spinach plant in the closed container or the consumer-ready-to-be-consumed lettuce plant in the closed container of the spinach or lettuce seed, the spinach or lettuce germinated seed, the spinach or lettuce seedling, or the small spinach or lettuce plant under suitable growing conditions,
wherein, said suitable conditions for growth to the consumer-ready-to-be-consumed spinach plant in the closed container or the consumer-ready-to-be-consumed lettuce plant in the closed container of the spinach or lettuce seed, the spinach or lettuce germinated seed, the spinach or lettuce seedling, or the small spinach or lettuce plant comprise suitable light intensity and color for optimal growth to the consumer-ready-to-be-consumed spinach plant in the closed container or the consumer-ready-to-be-consumed lettuce plant in the closed container;
b) sealing the container with a permeable membrane to obtain a closed container containing the materials for producing the consumer-ready-to-be-consumed spinach plant in the closed container or the consumer-ready-to-be-consumed lettuce plant in the closed container,
wherein said membrane is permeable to oxygen and carbon dioxide and impermeable to contamination and pathogens, and
c) growing in the closed container at the place for growth the spinach or lettuce seed, the spinach or lettuce germinated seed, the spinach or lettuce seedling, or the small spinach or lettuce plant under the suitable growing conditions until the consumer-ready-to-be-consumed spinach plant in the closed container or the consumer-ready-to-be-consumed lettuce plant in the closed container is produced,
whereby the consumer-ready-to-be-consumed spinach plant in the closed container or the consumer-ready-to-be-consumed lettuce plant in the closed container is produced.

2. The consumer-ready-to-be-consumed spinach plant or the consumer-ready-to-be-consumed lettuce plant of claim 1, wherein the method for producing the consumer-ready-to-be-consumed spinach plant or the consumer-ready-to-be-consumed lettuce plant further comprises:
b1) applying a label or wrap with information regarding the consumer-ready-to-be-consumed spinach plant in the closed container or the consumer-ready-to-be-consumed lettuce plant in the closed container to the container,
said applying occurring either prior to or after sealing the container with the partially self-adhesive membrane.

3. The consumer-ready-to-be-consumed spinach plant or the consumer-ready-to-be-consumed lettuce plant of claim 1, wherein the method for producing the consumer-ready-to-be-consumed spinach plant or the consumer-ready-to-be-consumed lettuce plant further comprises:
b2) transferring the closed container containing the materials for producing the consumer-ready-to-be-consumed spinach plant in the closed container or the consumer-ready-to-be-consumed lettuce plant in the closed container to a place for growth of the spinach or lettuce seed, the germinated spinach or lettuce seed, the spinach or lettuce seedling, or the small spinach or lettuce plant under the suitable growing conditions.

4. The consumer-ready-to-be-consumed spinach plant or the consumer-ready-to-be-consumed lettuce plant of claim 1, wherein
said consumer-ready-to-be-consumed spinach plant or said consumer-ready-to-be-consumed lettuce plant is grown at a retail outlet or a regional facility of the retail outlet.

5. The consumer-ready-to-be-consumed spinach plant or the consumer-ready-to-be-consumed lettuce plant of claim 1, wherein the consumer-ready-to-be-consumed lettuce plant is baby leaf lettuce.

6. The consumer-ready-to-be-consumed spinach plant or the consumer-ready-to-be-consumed lettuce plant of claim 1, wherein the consumer-ready-to-be-consumed lettuce plant is leaf lettuce.

7. The consumer-ready-to-be-consumed spinach plant or the consumer-ready-to-be-consumed lettuce plant of claim 1, wherein the consumer-ready-to-be-consumed lettuce plant is head lettuce.

8. The consumer-ready-to-be-consumed spinach plant or the consumer-ready-to-be-consumed lettuce plant of claim 1, wherein the seed for producing the consumer-ready-to-be-consumed spinach plant or the consumer-ready-to-be-consumed lettuce plant in steps a) i), ii), and iii) and c), is provided in the form of a seed mat or seed band.
